(19) United States
(12) Patent Application Publication
(10) Pub. No.: US 2026/0300650 A1
(43) Pub. Date: Oct. 1, 2026

(54) MACHINE TRANSLATION MODEL IMPROVEMENT USING LLM TECHNOLOGY

(71) Applicant: eBay Inc., San Jose, CA (US)

(72) Inventors: Roham Soleimani, Berlin (DE); Amirhossein Shaghaghi Saraskanroud, Berlin (DE)

(21) Appl. No.: 19/097,755

(22) Filed: Apr. 1, 2025

(51) Int. Cl. G06F 40/58; G06F 40/30; G06F 40/51

(52) U.S. Cl. CPC G06F 40/58; G06F 40/30; G06F 40/51

(57) ABSTRACT

Systems and methods are directed to improving machine translation models using large language model (LLM) technology. The system accesses chat data from a live chat that involves machine translation between two different languages performed by a machine translation model. A large language model (LLM) is prompted to analyze the chat data to detect a sentiment in substantially real-time. The LLM is also prompted to generate a reward signal based on the sentiment. Using the reward signal as a label, the system trains, in substantially real-time as the live chat, a live machine translation model associated with the machine translation between the two different languages. The system also offline trains an offline translation model based on stored text data for the two different languages. The system then determines whether to keep the machine translation model or replace it with the live machine translation model or the offline translation model.

### TECHNICAL FIELD

The subject matter disclosed herein generally relates to machine translation. Specifically, the present disclosure addresses systems and methods that use large language model (LLM) technology to train improved machine translation models.

### BACKGROUND

The use of machine translation is critical for communication especially in the context of sharing online content or enabling live communications. However, the generation or improvement of a single machine translation model (from a first language to a second language) requires much computing and human resources and is a timely process that includes evaluation and testing. This would be required for each language-to-language machine translation model. When an entity serves a large number of countries with different languages, the process of generating and improving all the different machine translation models can takes years.

### BRIEF DESCRIPTION OF THE DRAWINGS

FIG. 1 is a diagram illustrating an example network environment suitable for improving a machine translation model using LLM technology, according to example embodiments.

FIG. 2 is a diagram illustrating components of a translation system, according to example embodiments.

FIG. 3 is a diagram illustrating an example data flow within the translation system, according to example embodiments.

FIG. 4 is a diagram illustrating another example data flow within the translation system, according to example embodiments.

FIG. 5 is a flowchart illustrating a method for improving a machine translation model using LLM technology, according to example embodiments.

FIG. 6 is a flowchart illustrating a further method for improving a machine translation model using LLM technology, according to example embodiments.

FIG. 7 is a block diagram illustrating components of a machine, according to some examples, able to read instructions from a machine-storage medium and perform any one or more of the methodologies discussed herein.

### DETAILED DESCRIPTION

The description that follows describes systems, methods, techniques, instruction sequences, and computing machine program products that illustrate examples of the present subject matter. In the following description, for purposes of explanation, numerous specific details are set forth in order to provide an understanding of various examples of the present subject matter. It will be evident, however, to those skilled in the art, that examples of the present subject matter may be practiced without some or other of these specific details. Examples merely typify possible variations. Unless explicitly stated otherwise, structures (e.g., structural components) are optional and may be combined or subdivided, and operations (e.g., in a procedure, algorithm, or other function) may vary in sequence or be combined or subdivided.

Systems and methods that improve machine translation models using large language model (LLM) technology are discussed herein. In example embodiments, an LLM can be used to autonomously detect and extract inaccuracies from translation outputs. A reward signal or translation score (e.g., a translation quality score or translation uncertainty score) is assigned by the LLM to each translation samples. The reward signal or translation score acts as a label for the translation sample in subsequent machine learning. Thus, the translation samples along with the reward signal or translation score can be subsequently used to retrain or improve the machine translation models. Specifically, an online process can use the reward signal to perform reinforcement learning to improve a live machine translation model. Additionally, an offline training process can use a sample pool of translations having translation scores (e.g., translation quality scores and/or translation uncertainty scores) determined by the LLM to perform active learning to train an offline machine translation model. In some embodiments, a golden set is used to determine whether to replace the machine translation model with the live machine translation model or the offline machine translation model.

Example embodiments remove the need for humans to label training data (e.g., the good and poor translations) by using the LLM to determine sentiment, identify poor translations, and generate reward signals and translation scores which act as the labels. Additionally, example embodiments reduce the number of samples needed to improve a machine translation model. This removal of human interaction and reduced number of samples results in a system that is efficient and can produce results (e.g., new and improved translation models) in a fraction of the time and resources traditionally needed.

As a result, example embodiments provide a technical solution to the technical problem of machine translation model improvement. In particular, the technical solution uses the LLM to detect poor translations and to assign reward signals to translation samples. These translation samples are used to train new machine translation models which can replace the machine translation model that provided the poor translations. By essentially feeding the poor translations back into the translation system, a continuous improvement environment is provided. This improvement environment reduces the need for computation and human resources and reduces a timeline for training improved machine translation models.

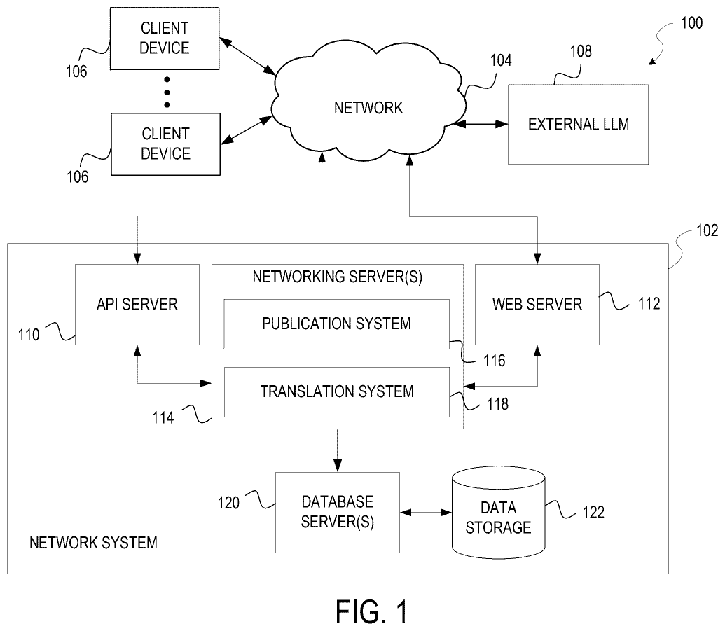

FIG. 1 is a diagram illustrating an example network environment suitable for improving a machine translation model using LLM technology, according to example embodiments. A network system 102 provides server-side functionality via a communication network 104 (e.g., the Internet, wireless network, cellular network, or a Wide Area Network (WAN)) to a plurality of client devices 106. The network system 102 is configured to provide machine translation for communications (e.g., live chats) and publications, as will be discussed in more detail below.

In example embodiments, each client device 106 is a device associated with a user of the network system 102. For example, the client device 106 can be a device associated with a user that uses the network system 102 to generate and post publications. In some cases, the client device 106 is associated with a user that uses the network system 102 to interact with the publications and/or the users that posted the publications.

The client device 106 may comprise, but is not limited to, a smartphone, a tablet, a laptop, multi-processor systems, microprocessor-based or programmable consumer electronics, a desktop computer, a server, or any other communication device that can access the network system 102. The client device 106 can include an application that exchanges data, via the network 104, with the network system 102. For example, the application can be browser application or a local version of an application associated with the network system 102 that can provide data to and access data from one or more components at the network system 102.

In example implementations, the client device 106 interfaces with the network system 102 via a connection with the network 104. Depending on the form of the client device 106, any of a variety of types of connections and networks 104 may be used. For example, the connection may be Code Division Multiple Access (CDMA) connection, a Global System for Mobile communications (GSM) connection, or another type of cellular connection. Such a connection may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks, 5G networks). When such technology is employed, the network 104 includes a cellular network that has a plurality of cell sites of overlapping geographic coverage, interconnected by cellular telephone exchanges. These cellular telephone exchanges are coupled to a network backbone (e.g., the public switched telephone network (PSTN), a packet-switched data network, or other types of networks.

In another example, the connection to the network 104 is a Wireless Fidelity (e.g., Wi-Fi, IEEE 802.11x type) connection, a Worldwide Interoperability for Microwave Access (WiMAX) connection, or another type of wireless data connection. In such an example, the network 104 includes one or more wireless access points coupled to a local area network (LAN), a wide area network (WAN), the Internet, or another packet-switched data network. In yet another example, the connection to the network 104 is a wired connection (e.g., an Ethernet link) and the network 104 is a LAN, a WAN, the Internet, or another packet-switched data network. Accordingly, a variety of different configurations are expressly contemplated.

An external LLM 108 is a third-party LLM that processes data on behalf of the network system 102. Generally, an LLM is a trained model configured to generate text and perform natural language processing tasks. Typically, the LLM learns relationships from an extremely large data set during a training process and can then be used to generate text by taking an input and repeatedly predicting a next token or word, for example. The training can be performed with data from many different languages. It is noted that if the network system 102 comprises an internal LLM, then the external LLM 108 may not be necessary.

Turning specifically to the network system 102, an application programing interface (API) server 110 and a web server 112 are coupled to and provide programmatic and web interfaces respectively to one or more networking servers 114. The networking servers 114 host various systems including a publication system 116 and a translation system 118, each comprising a plurality of components and each of which can be embodied as a combination of hardware, software, and/or firmware. The networking servers 114 can comprise other system based on the nature of the network system 102.

The publication system 116 is configured to manage publications (e.g., articles, documents, listings of available goods or services) at the network system 102 including generating and publishing the publications, conducting searches for publications, and/or tracking/processing interactions with the publications. The interactions can include, for example, clicking on a publication, viewing the publication, adding an item of the publication to a watchlist, or performing a transaction for an item of the publication.

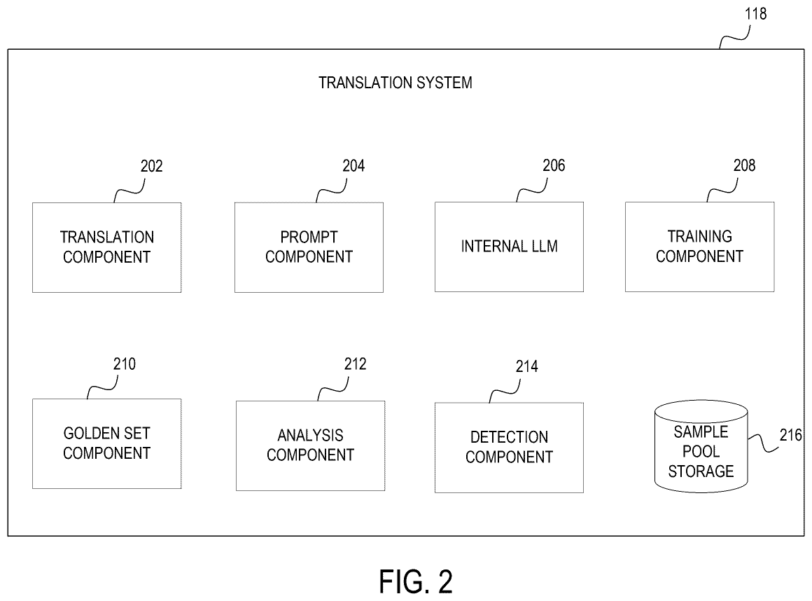

The translation system 118 is configured to provide machine translation services for the network system 102. In example embodiments, the machine translations can be for live chats between sets of two or more users of the network system 102 and for the publications that are generated in a first language that need to be displayed in a second language. The translation system 118 will be discussed in more detail in connection with FIG. 2 to FIG. 4 below.

The networking servers 114 can be, in turn, coupled to one or more database servers 120 that facilitate access to one or more storage repositories or data storage 122. The data storage 122 is a storage device storing, for example, user accounts including user profiles of users of the network system 102, records of transactions between the users of the network system 102, and user activities with the network system 102.

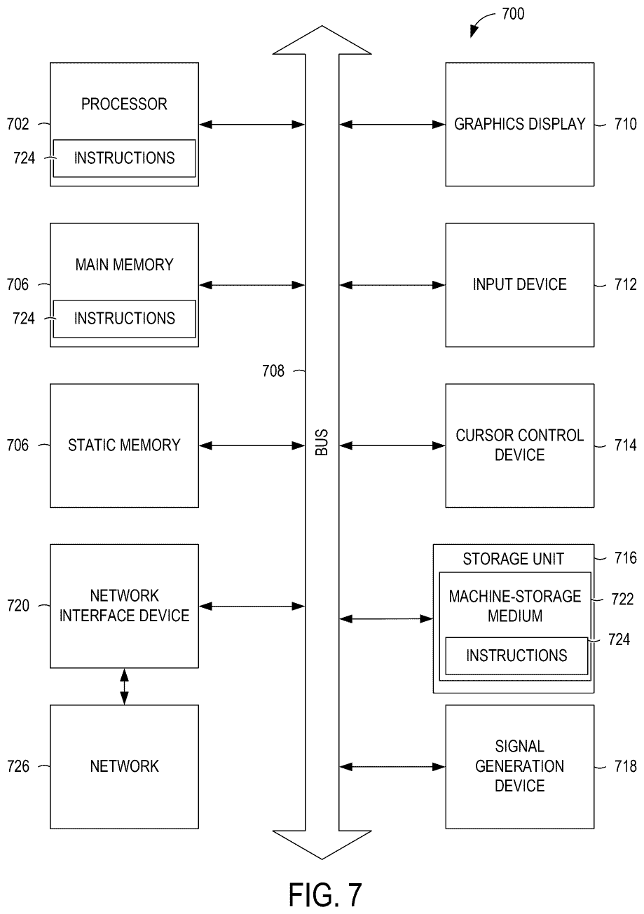

Any of the systems, data storage, servers, or devices (collectively referred to as “components”) shown in, or associated with, FIG. 1 may be, include, or otherwise be implemented in a special-purpose (e.g., specialized or otherwise non-generic) computer that can be modified (e.g., configured or programmed by software, such as one or more software components of an application, operating system, firmware, middleware, or other program) to perform one or more of the functions described herein for that system or machine. For example, a special-purpose computer system able to implement any one or more of the methodologies described herein is discussed below with respect to FIG. 7, and such a special-purpose computer is a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the components illustrated in FIG. 1 may be combined, and the functions described herein for any single component may be subdivided among multiple components. Functionalities of one component may, in alternative examples, be embodied in a different component. Additionally, any number of client devices 106 and data storage 122 may be embodied within the network environment 100. While only a single network system 102 is shown, alternatively, more than one network system 102 can be included (e.g., localized to a particular region).

FIG. 2 is a diagram illustrating components of the translation system 118, according to example implementations. In example embodiments, the translation system 118 comprises one or more servers that manages machine translation services and improvement of machine translation models using large language model (LLM) technology. To enable these operations, the translation system 118 comprises a translation component 202, a prompt component 204, an internal LLM 206, a training component 208, a golden set component 210, an analysis component 212, a detection component 214, and a sample pool storage 216, all configured in communication with one another (e.g., via a bus, shared memory, or a switch).

The translation component 202 is configured to provide machine translations to both live chats and stored text associated with the network system 102. The text can include, for example, the publications associated with the publication system 116 and general website content of the network system 102. In example embodiments, the translation component 202 comprises a plurality of machine translation models whereby each machine translation model translates between a different set of languages. For example, a first machine translation model can translate from English to Chinese, while a second machine translation model translates from German to English.

The prompt component 204 is configured to generate, without human interaction, prompts that triggers the LLM (e.g., the external LLM 108 or the internal LLM 206) to perform various operations including generating reward signals or translation scores. In example implementations, the prompt component 204 integrates inputs into one or more prompts that trigger the LLM. In some cases, the input is chat data from a live chat. In other cases, the input is the text content associated with the publication system 116 or generally with the network system 102.

In some embodiments, the prompt component 204 generates a prompt to determine a sentiment of the chat data. For example, if a translation is incorrect and a user in the live chat does not understand the translation, the user may respond in the live chat with a statement that indicates they do not understand or are frustrated. The prompt component 204 generates a prompt that can trigger the LLM to perform sentiment analysis on the chat data which assesses a tone associated with the chat data. An output may indicate whether the translation during the live chat is good or if there is a problem (bad).

In some embodiments, the prompt component 204 generates a prompt that triggers the LLM to determine a reward signal or translation score (collectively referred to as “score generation”) to associate with a translation. For example, the reward signal can comprise a score indicating a translation quality or translation uncertainty. The score can be numerical (e.g., a level of translation on a scale of one to ten or between a range of +5 to −5). Alternatively, the score can comprise a classification (e.g., extremely good, very good, good, neutral, bad, very bad, extremely bad) associated with a translation (e.g., a translation sample).

In some embodiments, the translation system 118 comprises or is in communication with the internal LLM 206, which is in-house or owned by the network system 102. In some embodiments, the internal LLM 206 is exclusively prompted by the prompts generated by the prompt component 204. In alternative embodiments, the prompts can be used to exclusively prompt the external LLM 108 (e.g., when there is no internal LLM 206). In further embodiments, both the internal LLM 206 and the external LLM 108 can be prompted. For example, one of the LLMs can be prompted for sentiment analysis and the other LLM can be prompted for score generation. While a single internal LLM 206 and external LLM 208 are shown, any number of LLMs may be present in the environment.

The training component 208 is configured to perform online training (e.g., live reinforcement learning) and offline training (e.g., active learning) of machine translation models. In example embodiments, the training is based on translation samples (e.g., extracted bad and/or good translations from the live chat or the text content) and their reward signals (e.g., scores or classifications). The training component 208 can train live (improved) machine translation models based on the live chat data and can train offline machine translation models based on stored content (e.g., stored text).

The golden set component 210 is configured to obtain a golden set that serves as a trusted reference to test performance of newly trained machine translation models. Since the golden set is carefully annotated and free of errors, it provides reliable feedback on how well the newly trained machine translation models are performing. In some embodiments, the golden set component 210 obtains the golden set from a user base on human evaluation. In some embodiments, the golden set component 210 can identify the most likely data that should be included in the golden set and provide those for human evaluation and confirmation.

The analysis component 212 is configured to determine whether to replace a current machine translation model with a newly trained machine translation model. In example embodiments, the analysis component 212 uses the golden set to test the newly trained machine translation model(s) compared to the current machine translation model on performance (e.g., percentage accuracy). Whichever translation model performs best will be released (or kept in the case of the currently machine translation model) for future use.

The detection component 214 is configured to determine poor translation samples from stored text content. In example embodiments, the detection component 214 identifies the samples based on low interaction rates compared to their original language. For example, if a publication in the original language has many views and saving to a watchlist but a translation of the publication did not have any interactions, the detection component 214 flags the translated publication as a potentially bad translation.

The samples that are flagged are where the current machine translation model is weak and can trigger an active learning cycle to train the machine translation model in its weakness. Thus, the flagged samples are then evaluated by the LLM for a translation uncertainty score (e.g., a number or classification) and stored to the sample pool storage 216.

The sample pool storage 216 is configured to store a sample pool of translation samples (along with their score or classification). The translation samples can range from accurate translations to extremely poor translations. The translation samples from the sample pool can be used to perform the offline machine translations model training. Additionally, the golden set can be derived from the sample pool.

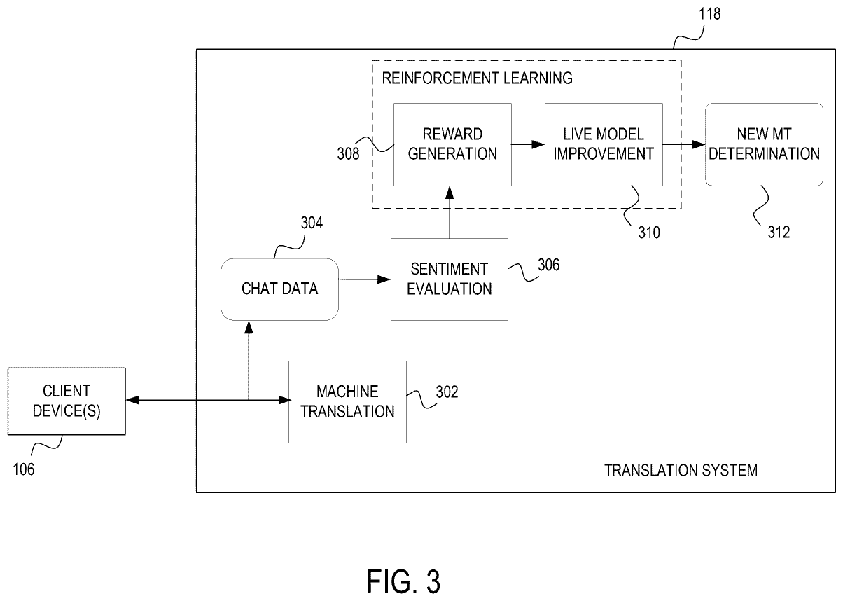

FIG. 3 is a diagram illustrating an example data flow within the translation system 118, according to example embodiments. The embodiment of FIG. 3 involves only live chat translations and live, reinforcement learning. During a live chat, the client devices 106 of the users that are chatting provide content to the network system 102 which is forwarded to a machine translation model (e.g., within the translation component 202). The machine translation model perform the machine translation 302 of the content and provides the translation back to at least one of the client devices 106. This continuously occurs during the duration of the live chat.

The content that includes the translations is chat data 304 that is evaluated to determine if there is a bad translation. In example embodiments, the prompt component 204 accesses the chat data 304 and generates a prompt that requests the LLM (e.g., external LLM 108, internal LLM 206) to perform a sentiment evaluation on the chat data 304. The prompt component 204 can comprise predefined templates that are designed for various tasks. Thus, a predefined template can be “perform sentiment evaluation for the following text: [input],” whereby the input is a portion of the chat data that includes the translation. Similarly, predefined templates can be used by the prompt component 204 to trigger generation of reward signals.

The prompt triggers the LLM to perform sentiment evaluation 306. The LLM evaluates a sentiment of the chat data by leveraging its ability to understand human language to determine a tone or sentiment expressed in the chat data. Thus, the LLM analyzes context, word usage, tone, and syntax to infer whether the sentiment is positive, negative, or neutral in the chat data. For example, when one of the users does not understand the translations, the user may take a negative tone in the chat and indicate that they do not understand. A negative sentiment can be an indication of a bad translation, while a positive sentiment can indicate a good translation.

After the sentiment of the portion of the chat data is determined, the portion can be marked based on the sentiment. Thus, each translation in the live chat can be marked as, for example, a good, poor, or neutral translation.

Next, the LLM is prompted to generate a reward signal 308 for each translation sample. In some embodiments, the reward signal comprises a translation quality score (e.g., number or classification). For example, the translation can be scored on a scale of −5 to +5 where −5 means the translation is completely wrong and +5 means the translation is completely accurate. In these embodiments, the prompt can include instructions that the LLM has a scale from −5 to +5 to score with and include examples that show application of scores. For example, a predefined template can be used that indicates “generate a reward signal for the following text: [input] and use a scale from −5 to +5” and provides the examples. In alternative embodiments, the reward signal comprises a classification. For example, the classifications can include extremely bad translation, very bad translation, bad translation, neutral translation, good translation, very good translation, and extremely good translation. In these embodiments, the prompt can include the different classifications, examples of application of the different classifications, and instructions to classify each translation based on the examples.

The scores can then be used as a reward mechanism for the reinforcement learning. The reinforcement learning is live or real-time training (e.g., as the live chat continues). Thus, the translations along with their reward signals are provided to the training component 208 which attempts to perform a live model improvement 310. Because the improvement can occur in substantially real-time, the live machine translation model can be used immediately to translate the live chat.

An analysis can be performed to determine whether to replace a current machine translation model with the live machine translations model 312 for all future uses of the translation system 118. If the analysis indicates that the live machine translation model performs better than the current machine translation model, the live machine translation model can be released as the new machine translation model for future use.

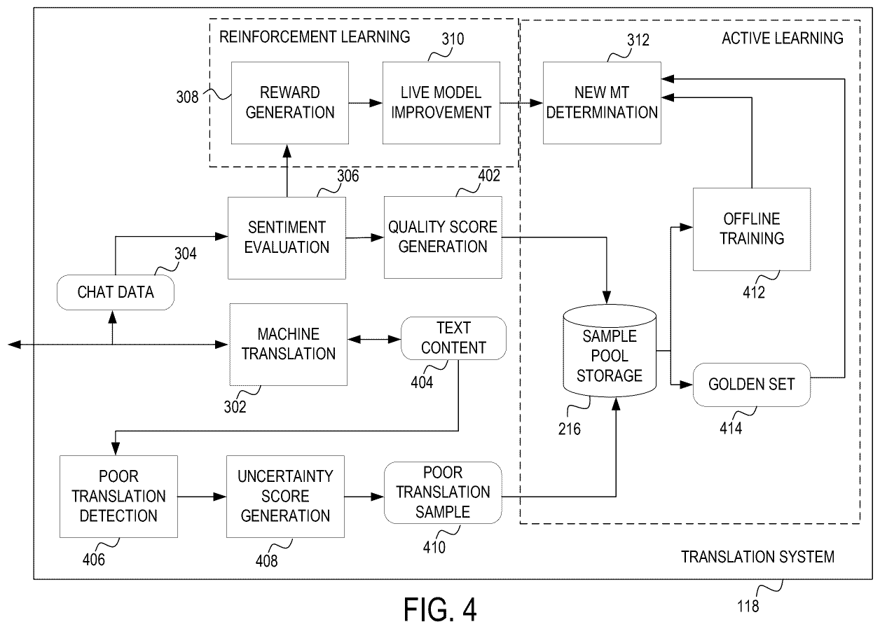

FIG. 4 is a diagram illustrating another example data flow within the translation system 118, according to example embodiments. The embodiment of FIG. 4 expands on the embodiment of FIG. 3 by including an offline training portion. The live chat and reinforcement learning portion remains the same. An additional operation of generating a translation quality score 402 is included. The generation of the translation quality score 402 is a similar process as generating the reward signal 308. Thus, the LLM is prompted to generate the translation quality score for each translation. As such, the prompt can include a range for the translation quality score, examples of application of the range to different translations, and instructions to generate the translation quality score for each translation based on the examples.

In some embodiments, if the translation quality is bad (e.g., the translation quality score is less than −2), the translation along with the score is stored to the sample pool storage 216. In some embodiments, the LLM may also be prompted to provide a suggest correct translation for the bad translation. This prompting may be included with the prompt to generate the translation quality score. In these embodiments, the suggested, correct translation is stored to the sample pool storage 216 with the bad translation and translation quality score. In some embodiments, all translation samples (e.g., good and bad) along with their translation quality score are stored to the sample pool storage 216.

In embodiments where the reward signal is also a translation quality score, the two generation operations 308 and 402 can combined into a single generation operation. A resulting single translation quality score can then be used in reinforcement learning to train/improve the live machine translation model 310. Additionally, the same translation quality score can be stored to the sample pool storage 216 with the corresponding translation and, in cases of bad translation, a suggested, correct translation.

The translation system 118 is also configured to analyze stored content (e.g., text content 404) for translation quality and to train machine translation models offline. The text content 404 can include the publications associated with the publication system 116, general website content of the network system 102, and corresponding translations.

Initially, poor translation detection 406 is performed by the detection component 214. In example embodiments, the detection component 214 identifies poor translation samples based on low interaction rates compared to the corresponding text in an original language. For example, if a publication in the original language has a lot of transactions (e.g., purchases or bids) but a translation of the publication does not have any interactions or very few (e.g., a few views but no transactions), the detection component 214 flags the translated publication as a potentially bad translation sample.

Translation uncertainty scores generation 408 is then performed. In example embodiments, the LLM is prompted to evaluate the flagged samples and generate the translation uncertainty score for each flagged sample (e.g., from 0 to −10). Each poor translation sample 410 along with its corresponding translation uncertainty score is stored to the sample pool storage 216. In some embodiments, the translation uncertainty score is a translation quality score.

The sample pool storage 216 contains translation samples along with their corresponding scores and/or suggested, correct translations. An aggregate of the translation samples is referred to as a sample pool. In example embodiments, the sample pool is used to offline train 412 a new (offline) machine translation model. In some embodiments, the live model improvements 310 can also be added to the sample pool.

In example embodiments, a golden set 414 is obtained by the golden set component 210. The golden set 414 then serves as a trusted reference to test performance of newly trained machine translation models. The golden set 414 includes completely accurate translations and thus, can also be a target for the offline translation models to be trained on.

In example embodiments, analysis is performed using the golden set 414 to determine whether to replace the current machine translation model 302 with the live machine translations model (from the live model improvement 310) or the offline machine translation model (from the offline training 412). The analysis determines which of the three machine translation models performs best with the golden set. The machine translation model that performs the best will be released as the new (or original) machine translation model to be used going forward. In some cases, the release may be gradual. For example, the translation system 118 can start redirecting traffic from the original/current machine translation model to the new machine translation model and eventually replace the original machine translation model. In some cases, the original machine translation model 302 can still perform better than either the live machine translation model or the offline machine translation model and no new release is needed.

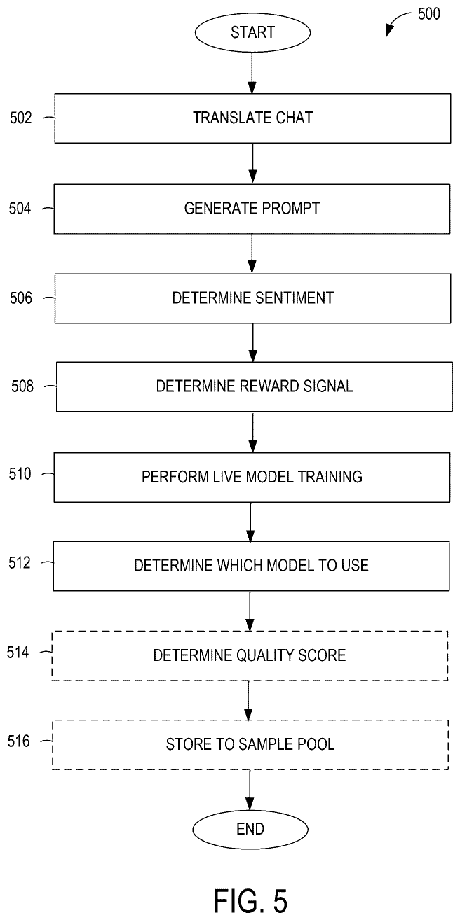

FIG. 5 is a flowchart illustrating a method 500 for improving a machine translation model using LLM technology, according to example embodiments. Operations in the method 500 may be performed by the translation system 118, using components described above in part with respect to FIG. 2. Accordingly, the method 500 is described by way of example with reference to the translation system 118. However, it shall be appreciated that at least some of the operations of the method 500 may be deployed on various other hardware configurations or be performed by similar components residing elsewhere in the network environment 100. Therefore, the method 500 is not intended to be limited to the translation system 118.

The method 500 involves the translation of a live chat session between users in two different languages and reinforcement learning. The live chat messages (e.g., chat content) are received by the network system 102 and forwarded to the translation component 202. In operation 502, the translation component 202 translates the chat content from an original language of a first user to a language of a second user in the live chat session. The translation is performed by a machine translation model.

In operation 504, the prompt component 204 generates one or more prompts to trigger operations by the LLM (e.g., the external LLM 108, the internal LLM 206). As such, the prompt component 204 accesses the chat data (including translations) from the live chat. The prompt component 204 then generates a prompt that includes the chat data and instructions to determine a sentiment for the chat data. In some cases, the prompt can also include instructions to generate a reward signal (e.g., a translation quality score). Alternatively, a second prompt can be generated to generate the reward signal.

In operation 506, the LLM is prompted to determine the sentiment of the chat data. The LLM evaluates a sentiment of the chat data by leveraging its ability to understand human language to determine a tone or sentiment expressed in the chat data. Thus, the LLM analyzes context, word usage, tone, and syntax of the chat data to infer whether the sentiment is positive, negative, or neutral in the chat data. After the sentiment of a portion of the chat data is determined (e.g., a particular translation), the portion can be marked with the sentiment.

In operation 508, the LLM is prompted to determine the reward signal. In some embodiments, the reward signal comprises a translation quality score (e.g., on a 10-point scale). In alternative embodiments, the reward signal comprises a classification (e.g., good, neutral, bad). The scores can then be used as a reward mechanism for reinforcement learning.

In operation 510, the training component 208 performs live model training using reinforcement learning. In example embodiments, the training is in substantially real-time as the real-time or live chat. Thus, in some cases, a live machine translation model that is being trained can be used to immediately improve the translation between the two different languages of the live chat.

In reinforcement training, the goal is to maximize rewards and minimize impact of bad data on the model's performance. The training data includes the translation samples (good and bad) and their reward signals (e.g., scores or classifications). In training, a reward function can assign higher rewards for the good translation samples and lower (or negative) rewards for the poor translation samples. The reward signals can be used to adjust internal parameters of the translation model.

In operation 512, the analysis component 212 determines which model (e.g., the original/current machine translation model or the live machine translations model) to use in subsequent translations for all users. In some embodiments, the determination is based on which model performs better with a golden set.

In operation 514, a translation quality score can be determined by the LLM that can be used in offline training. The generation of the translation quality score is a similar process as determining the reward signal in operation 508. In embodiments where the reward signal is also a translation quality score, operation 514 would simply use the translations quality score form operation 508. In some cases, the LLM is also prompted to provide a suggested, correct translation for bad translations.

In operation 516, the portion of the live chat (e.g., the translation) is stored to the sample pool along with the translation quality score. A suggested, correct translation can also be stored with the translation in cases where the translation is determined to be poor.

It is noted that operation 512 and 514 are optional. The results of these operations can be used in offline training. Thus, in embodiments where only reinforcement training is performed live or online, operation 512 and 514 are not necessary.

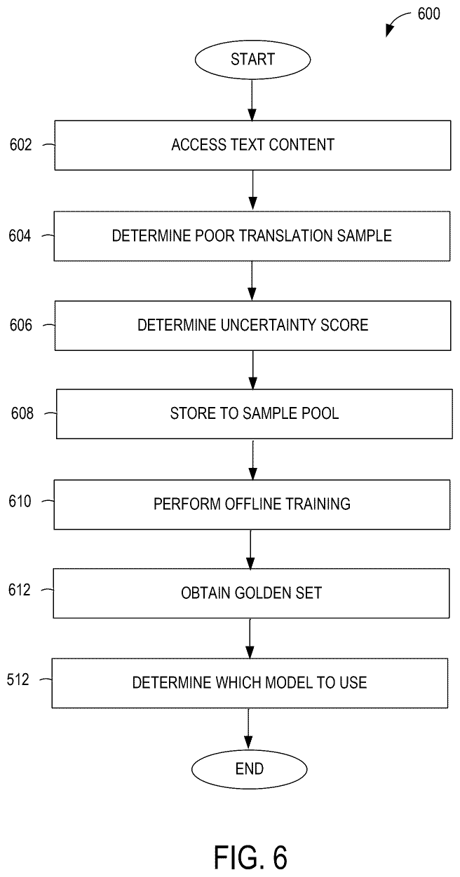

FIG. 6 is a flowchart illustrating a further method 600 for improving a machine translation model using LLM technology, according to example embodiments. Operations in the method 600 may be performed by the translation system 118, using components described above in part with respect to FIG. 2. Accordingly, the method 600 is described by way of example with reference to the translation system 118. However, it shall be appreciated that at least some of the operations of the method 600 may be deployed on various other hardware configurations or be performed by similar components residing elsewhere in the network environment 100. Therefore, the method 600 is not intended to be limited to the translation system 118.

The method 600 expands on the method 500 of FIG. 5 by including an offline training portion based, in part, on stored text content. In operation 602, the stored text content is accessed by the detection component 214. The text content 404 can include the publications associated with the publication system 116, general website content of the network system 102, and corresponding translations.

In operation 604, the detection component 214 determines poor translation sample from the text content. The detection component 214 identifies poor translation samples based on low interaction rates compared to the corresponding text in an original language. Thus, if a portion of a website in the original language has a lot of interactions (e.g., clicks, views) but a translation of the portion in a different language does not have any interactions or very few interactions, the detection component 214 flags the translated portion as a potentially bad translation sample.

In operation 606, the LLM is prompted to determine a translation uncertainty score for the translation sample. Thus, a prompt is generated by the prompt component 204 that includes the translation sample and instructions to determine the translation uncertainty score. The prompt can include examples of how the translation uncertainty score is determined. It is noted that the translation uncertainty score can be a number or a classification. For example, the classification can indicate that the translations is, for example, extremely poor, very poor, moderately poor, marginally poor, or slightly poor. In some embodiments, the translation uncertainty score is a translation quality score.

In operation 608, the translation sample with the poor translation along with the translation uncertainty score is stored to sample pool by the detection component 214. The sample pool is used to offline train a new (offline) machine translation model.

In some embodiments, the LLM may be prompted to determine a correct translation for the translation sample. In these embodiments, the correct translation is stored with the translation sample in the sample pool.

In operation 610, the training component 208 performs offline training using the sample pool. In some embodiments, the sample pool includes the samples from the chat data that was stored to the sample pool in operation 516. The sample pool can include both bad translations and good translations which can be used as training data for the offline training.

The training of the offline translation model starts with preparing a dataset from the sample pool. The dataset includes the translation samples (e.g., source text and translations) and corresponding labels generated by the LLM (e.g., the translations quality/uncertainty score) which indicates if the translation is good or poor. The dataset can be preprocessed (e.g., normalized). The translation model is then trained to distinguish patterns in good versus bad translations.

In operation 612, the golden set component 210 obtains the golden set. The golden set 414 serves as a trusted reference set to test performance of the newly trained machine translation models. In some embodiments, the golden set is generated from the sample pool. Thus, in operation 512, the analysis component 212 applies the golden set to the current, live, and offline machine translation models. The machine translation model exhibiting the best performance (e.g., highest percent accuracy) with the golden set is then selected to be the new machine translations model which is released for use.

In an alternative embodiment, the new machine translation model that is released can be a combination of the current, live, and offline machine translation models. For example, a translation for a word (or phrase) from the current, live, and offline machine translation models that is the best gets taken to the new machine translation model.

It is noted that the methods 500 and 600 is repeated for each machine translation model between two distinct languages. Additionally, some embodiments may include the use of the golden set in the offline training. In these embodiments, operation 612 is performed before operation 610.

FIG. 7 illustrates components of a machine 700, according to some example implementations, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 7 shows a diagrammatic representation of the machine 700 in the example form of a computer device (e.g., a computer) and within which instructions 724 (e.g., software, a program, an application, an applet, an app, or other executable code) for causing the machine 700 to perform any one or more of the methodologies discussed herein may be executed, in whole or in part.

For example, the instructions 724 may cause the machine 700 to execute the flow diagram of FIG. 5 and FIG. 6. In one implementation, the instructions 724 can transform the machine 700 into a particular machine (e.g., specially configured machine) programmed to carry out the described and illustrated functions in the manner described.

In alternative implementations, the machine 700 operates as a standalone device or may be connected (e.g., networked) to other machines. In a networked deployment, the machine 700 may operate in the capacity of a server machine or a client machine in a server-client network environment, or as a peer machine in a peer-to-peer (or distributed) network environment. The machine 700 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 724 (sequentially or otherwise) that specify actions to be taken by that machine. Further, while only a single machine is illustrated, the term “machine” shall also be taken to include a collection of machines that individually or jointly execute the instructions 724 to perform any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more components described herein.

The machine 700 may further include a graphics display 710 (e.g., a plasma display panel (PDP), a light emitting diode (LED) display, a liquid crystal display (LCD), a projector, or a cathode ray tube (CRT), or any other display capable of displaying graphics or video). The machine 700 may also include an input device 712 (e.g., a keyboard), a cursor control device 714 (e.g., a mouse, a touchpad, a trackball, a joystick, a motion sensor, or other pointing instrument), a storage unit 716, a signal generation device 718 (e.g., a sound card, an amplifier, a speaker, a headphone jack, or any suitable combination thereof), and a network interface device 720.

The storage unit 716 includes a machine-storage medium 722 (e.g., a tangible machine-storage medium) on which is stored the instructions 724 (e.g., software) embodying any one or more of the methodologies or functions described herein. The instructions 724 may also reside, completely or at least partially, within the main memory 704, within the processor 702 (e.g., within the processor's cache memory), or both, before or during execution thereof by the machine 700. Accordingly, the main memory 704 and the processor 702 may be considered as machine-storage media (e.g., tangible and non-transitory machine-storage media). The instructions 724 may be transmitted or received over a network 726 via the network interface device 720.

In some example implementations, the machine 700 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the components described herein.

### Executable Instructions and Machine-Storage Medium

The various memories (e.g., 704, 706, and/or memory of the processor(s) 702) and/or storage unit 716 may store one or more sets of instructions and data structures (e.g., software) 724 embodying or utilized by any one or more of the methodologies or functions described herein. These instructions, when executed by processor(s) 702 cause various operations to implement the disclosed implementations.

As used herein, the terms “machine-storage medium,” “device-storage medium,” “computer-storage medium” (referred to collectively as “machine-storage medium 722”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 722 include non-volatile memory, including by way of example semiconductor memory devices, for example, erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media 722 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 724 may further be transmitted or received over a communications network 726 using a transmission medium via the network interface device 720 and utilizing any one of a number of well-known transfer protocols (e.g., HTTP). Examples of communication networks 726 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” shall be taken to include any intangible medium that is capable of storing, encoding, or carrying instructions 724 for execution by the machine 700, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example implementations, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some implementations, a hardware component may be implemented mechanically, electronically, or any suitable combination thereof. For example, a hardware component may include dedicated circuitry or logic that is permanently configured to perform certain operations. For example, a hardware component may be a special-purpose processor, such as a field programmable gate array (FPGA) or an ASIC. A hardware component may also include programmable logic or circuitry that is temporarily configured by software to perform certain operations. For example, a hardware component may include software encompassed within a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where the hardware component comprises a general-purpose processor configured by software to become a special-purpose processor, the general-purpose processor may be configured as respectively different special-purpose processors (e.g., comprising different hardware components) at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, a processor being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example implementations, the one or more processors or processor-implemented components may be located in a single geographic location (e.g., within a home environment, an office environment, or a server farm). In other example implementations, the one or more processors or processor-implemented components may be distributed across a number of geographic locations.

### EXAMPLES

Example 1 is a method for improving a machine translation model using LLM technology. The method comprises accessing chat data from a live chat that involves machine translation between two different languages performed by a machine translation model; prompting a large language model (LLM) to analyze the chat data to detect a sentiment in substantially real-time; generating a reward signal based on the sentiment; using the reward signal as a label, training, in substantially real-time as the live chat, a live machine translation model associated with the machine translation between the two different languages; and determining whether to replace the machine translation model with the live machine translation model.

In example 2, the subject matter of example 1 can optionally include accessing stored text content that involves the machine translation between the two different languages; detecting a poor translation for a sample of the stored text content based on a low interaction rate with a translation of the sample in comparison with the sample in an original language; generating a translation uncertainty score for the sample with the poor translation; and storing the sample with the poor translation and the translation uncertainty score to a sample pool.

In example 3, the subject matter of any of examples 1-2 can optionally include wherein the stored text content comprises publications or general website content and their translations.

In example 4, the subject matter of any of examples 1-3 can optionally include wherein the generating the translation uncertainty score comprises generating, without human intervention, a prompt that includes the sample, instructions to determine the translation uncertainty score, and examples of how the translation uncertainty score is determined; and prompting the LLM using the prompt.

In example 5, the subject matter of any of examples 1-4 can optionally include training an offline machine translation model using the sample pool.

In example 6, the subject matter of any of examples 1-5 can optionally include accessing a golden set generated from the sample pool, the golden set comprising samples from the sample pool that are certain to comprise correct translations; and using the golden set as a test dataset to determine whether to keep the machine translation model or replace the machine translation model with the live translation model or the offline machine translation model.

In example 7, the subject matter of any of examples 1-6 can optionally include wherein the reward signal comprises a number or classification that is generated by the LLM.

In example 8, the subject matter of any of examples 1-7 can optionally include wherein the sentiment indicates that the chat data comprises a poor translation, the method further comprising recording the poor translation from the live chat in a sample pool with a suggested, correct translation; and training an offline machine translation model using the sample pool.

In example 9, the subject matter of any of examples 1-8 can optionally include wherein determining whether to replace the machine translation model with the live machine translation model comprises selecting between the machine translation model, the live machine translation model, and the offline machine translation model based on best performance.

In example 10, the subject matter of any of examples 1-9 can optionally include wherein the prompting the LLM to analyze the chat data to detect the sentiment comprises generating, without human intervention, a prompt with instructions to perform a sentiment evaluation and an indication of the chat data; and prompting the LLM using the prompt.

In example 11, the subject matter of any of examples 1-10 can optionally include wherein the generating the reward signal comprises generating, without human intervention, a prompt with instructions to generate the reward signal, a range for the reward signal, and examples of reward signal application; and prompting the LLM using the prompt

Example 12 is a system for improving a machine translation model using LLM technology. The system comprises one or more processors and a memory storing instructions that, when executed by the one or more processors, cause the one or more processors to perform operations comprising accessing chat data from a live chat that involves machine translation between two different languages performed by a machine translation model; prompting a large language model (LLM) to analyze the chat data to detect a sentiment in substantially real-time; generating a reward signal based on the sentiment; using the reward signal as a label, training, in substantially real-time as the live chat, a live machine translation model associated with the machine translation between the two different languages; and determining whether to replace the machine translation model with the live machine translation model.

In example 13, the subject matter of example 12 can optionally include wherein the operations further comprise accessing stored text content that involves the machine translation between the two different languages; detecting a poor translation for a sample of the stored text content based on a low interaction rate with a translation of the sample in comparison with the sample in an original language; generating a translation uncertainty score for the sample with the poor translation; and storing the sample with the poor translation and the translation uncertainty score to a sample pool.

In example 14, the subject matter of any of examples 12-13 can optionally include wherein the operations further comprise training an offline machine translation model using the sample pool.

In example 15, the subject matter of any of examples 12-14 can optionally include wherein the operations further comprise accessing a golden set generated from the sample pool, the golden set comprising samples from the sample pool that are certain to comprise correct translations; and using the golden set as a test dataset to determine whether to keep the machine translation model or replace the machine translation model with the live translation model or the offline machine translation model.

In example 16, the subject matter of any of examples 12-15 can optionally include wherein the sentiment indicates that the chat data comprises a poor translation, the operations further comprising recording the poor translation from the live chat in a sample pool with a suggested, correct translation; and training an offline machine translation model using the sample pool.

In example 17, the subject matter of any of examples 12-16 can optionally include wherein determining whether to replace the machine translation model with the live machine translation model comprises selecting between the machine translation model, the live machine translation model, and the offline machine translation model based on best performance.

In example 18, the subject matter of any of examples 12-17 can optionally include wherein the prompting the LLM to analyze the chat data to detect the sentiment comprises generating, without human intervention, a prompt with instructions to perform a sentiment evaluation and an indication of the chat data; and prompting the LLM using the prompt.

In example 19, the subject matter of any of examples 12-18 can optionally include wherein the generating the reward signal comprises generating, without human intervention, a prompt with instructions to generate the reward signal, a range for the reward signal, and examples of reward signal application; and prompting the LLM using the prompt.

Example 20 is a machine-storage medium comprising instructions which, when executed by one or more processors of a machine, cause the machine to perform operations for improving a machine translation model using LLM technology. The operations comprise accessing chat data from a live chat that involves machine translation between two different languages performed by a machine translation model; prompting a large language model (LLM) to analyze the chat data to detect a sentiment in substantially real-time; generating a reward signal based on the sentiment; using the reward signal as a label, training, in substantially real-time as the live chat, a live machine translation model associated with the machine translation between the two different languages; and determining whether to replace the machine translation model with the live machine translation model.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific examples, various modifications and changes may be made to these examples without departing from the broader scope of examples of the present invention. For instance, various examples or features thereof may be mixed and matched or made optional by a person of ordinary skill in the art. Such examples of the present subject matter may be referred to herein, individually or collectively, by the term “invention” merely for convenience and without intending to voluntarily limit the scope of this application to any single invention or present concept if more than one is, in fact, disclosed.

The examples illustrated herein are believed to be described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various examples of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of examples of the present invention as represented by the appended claims. The specification and drawings are, accordingly, to be regarded in an illustrative rather than a restrictive sense.

What is claimed is:

1. A method comprising:
accessing chat data from a live chat that involves machine translation between two different languages performed by a machine translation model;
prompting a large language model (LLM) to analyze the chat data to detect a sentiment in substantially real-time;
generating a reward signal based on the sentiment;
using the reward signal as a label, training, in substantially real-time as the live chat, a live machine translation model associated with the machine translation between the two different languages; and
determining whether to replace the machine translation model with the live machine translation model.

2. The method of claim 1, further comprising:
accessing stored text content that involves the machine translation between the two different languages;
detecting a poor translation for a sample of the stored text content based on a low interaction rate with a translation of the sample in comparison with the sample in an original language;
generating a translation uncertainty score for the sample with the poor translation; and
storing the sample with the poor translation and the translation uncertainty score to a sample pool.

3. The method of claim 2, wherein the stored text content comprises publications or general website content and their translations.

4. The method of claim 2, wherein the generating the translation uncertainty score comprises:
generating, without human intervention, a prompt that includes the sample, instructions to determine the translation uncertainty score, and examples of how the translation uncertainty score is determined; and
prompting the LLM using the prompt.

5. The method of claim 2, further comprising:
training an offline machine translation model using the sample pool.

6. The method of claim 5, further comprising:
accessing a golden set generated from the sample pool, the golden set comprising samples from the sample pool that are certain to comprise correct translations; and
using the golden set as a test dataset to determine whether to keep the machine translation model or replace the machine translation model with the live translation model or the offline machine translation model.

7. The method of claim 1, wherein the reward signal comprises a number or classification that is generated by the LLM.

8. The method of claim 1, wherein the sentiment indicates that the chat data comprises a poor translation, the method further comprising:
recording the poor translation from the live chat in a sample pool with a suggested, correct translation; and
training an offline machine translation model using the sample pool.

9. The method of claim 8, wherein determining whether to replace the machine translation model with the live machine translation model comprises selecting between the machine translation model, the live machine translation model, and the offline machine translation model based on best performance.

10. The method of claim 1, wherein the prompting the LLM to analyze the chat data to detect the sentiment comprises:
generating, without human intervention, a prompt with instructions to perform a sentiment evaluation and an indication of the chat data; and
prompting the LLM using the prompt.

11. The method of claim 1, wherein the generating the reward signal comprises:
generating, without human intervention, a prompt with instructions to generate the reward signal, a range for the reward signal, and examples of reward signal application; and
prompting the LLM using the prompt.

12. A system comprising:
one or more processors; and
a memory storing instructions that, when executed by the one or more processors, cause the one or more processors to perform operations comprising:
accessing chat data from a live chat that involves machine translation between two different languages performed by a machine translation model;
prompting a large language model (LLM) to analyze the chat data to detect a sentiment in substantially real-time;
generating a reward signal based on the sentiment;
using the reward signal as a label, training, in substantially real-time as the live chat, a live machine translation model associated with the machine translation between the two different languages; and
determining whether to replace the machine translation model with the live machine translation model.

13. The system of claim 12, wherein the operations further comprise:
accessing stored text content that involves the machine translation between the two different languages;
detecting a poor translation for a sample of the stored text content based on a low interaction rate with a translation of the sample in comparison with the sample in an original language;
generating a translation uncertainty score for the sample with the poor translation; and
storing the sample with the poor translation and the translation uncertainty score to a sample pool.

14. The system of claim 13, wherein the operations further comprise:
training an offline machine translation model using the sample pool.

15. The system of claim 14, wherein the operations further comprise:
accessing a golden set generated from the sample pool, the golden set comprising samples from the sample pool that are certain to comprise correct translations; and
using the golden set as a test dataset to determine whether to keep the machine translation model or replace the machine translation model with the live translation model or the offline machine translation model.

16. The system of claim 12, wherein the sentiment indicates that the chat data comprises a poor translation, the operations further comprising:
recording the poor translation from the live chat in a sample pool with a suggested, correct translation; and
training an offline machine translation model using the sample pool.

17. The system of claim 16, wherein determining whether to replace the machine translation model with the live machine translation model comprises selecting between the machine translation model, the live machine translation model, and the offline machine translation model based on best performance.

18. The system of claim 12, wherein the prompting the LLM to analyze the chat data to detect the sentiment comprises:
generating, without human intervention, a prompt with instructions to perform a sentiment evaluation and an indication of the chat data; and
prompting the LLM using the prompt.

19. The system of claim 12, wherein the generating the reward signal comprises:
generating, without human intervention, a prompt with instructions to generate the reward signal, a range for the reward signal, and examples of reward signal application; and
prompting the LLM using the prompt.

20. A machine-storage medium comprising instructions which, when executed by one or more processors of a machine, cause the machine to perform operations comprising:
accessing chat data from a live chat that involves machine translation between two different languages performed by a machine translation model;
prompting a large language model (LLM) to analyze the chat data to detect a sentiment in substantially real-time;
generating a reward signal based on the sentiment;
using the reward signal as a label, training, in substantially real-time as the live chat, a live machine translation model associated with the machine translation between the two different languages; and
determining whether to replace the machine translation model with the live machine translation model.
